(19) United States
(12) Patent Application Publication
(10) Pub. No.: US 2004/0099980 A1
(43) Pub. Date: May 27, 2004

(54) Method of preparing a partially foamed acrylic container

(76) Inventor: Ying-Hui Shen, Taichung (TW)

Correspondence Address: Ying-Hui Shen, 58, MA YUAN WEST ST., TAICHUNG, TW

(21) Appl. No.: 10/307,147

(22) Filed: Nov. 26, 2002

(51) Int. Cl. B29C 44/02; B29C 44/06

(52) U.S. Cl. 264/45.1

(57) ABSTRACT

A method of preparing a partially foamed acrylic container has steps of adding a foaming agent into an acrylic material; increasing a temperature to melt the acrylic material; injection molding the acrylic material to form an acrylic container having walls with various thickness; producing foams on a thick wall of the acrylic container, and a thickness of the thick wall larger than 1.5 mm.

### BACKGROUND OF THE INVENTION

The present invention relates to a method of preparing an acrylic container. More particularly, the present invention relates to a method of preparing a partially foamed acrylic container.

Referring to FIG. 1, a conventional acrylic container 100 has a large number of foams distributed in a wall of the conventional acrylic container evenly.

### SUMMARY OF THE INVENTION

An object of the present invention is to provide a method of preparing a partially foamed acrylic container which has a large number of foams formed in a thick wall of the partially foamed acrylic container. The partially foamed acrylic container has walls with various thickness.

Accordingly, a method of preparing a partially foamed acrylic container comprises steps of adding a foaming agent into an acrylic material; increasing a temperature to melt the acrylic material; injection molding the acrylic material to form an acrylic container having walls with various thickness; producing foams on a thick wall of the acrylic container, and a thickness of the thick wall larger than 1.5 mm.

### BRIEF DESCRIPTION OF THE DRAWINGS

FIG. 1 is a perspective view of a conventional acrylic container of the prior art;

FIG. 2 is a flow chart showing a method of preparing a partially foamed acrylic container of a preferred embodiment in accordance with the present invention;

FIG. 3 is a perspective view of a partially foamed acrylic container having a plurality of inner protruded bars;

FIG. 3A is a sectional view of FIG. 3;

FIG. 4 is a perspective view of a partially foamed acrylic container having a plurality of outer protruded bars;

FIG. 5 is a perspective view of a partially foamed acrylic container having a heart-shaped outer protrusion;

FIG. 6 is a flow chart showing a method of preparing a partially foamed acrylic container of another preferred embodiment in accordance with the present invention;

FIG. 7 is a perspective exploded view of a partially foamed acrylic container and an outer casing;

FIG. 8 is a perspective assembly view of a partially foamed acrylic container and an outer casing; and

FIG. 8A is a top plan view of FIG. 8.

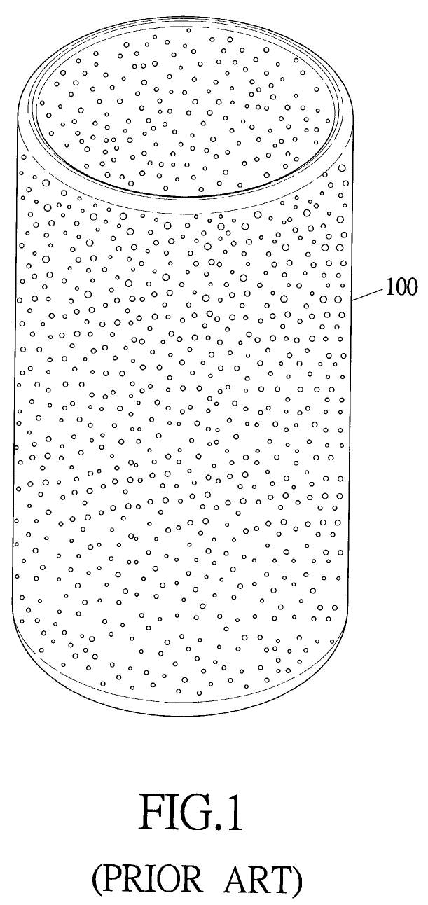

### DETAILED DESCRIPTION OF THE INVENTION

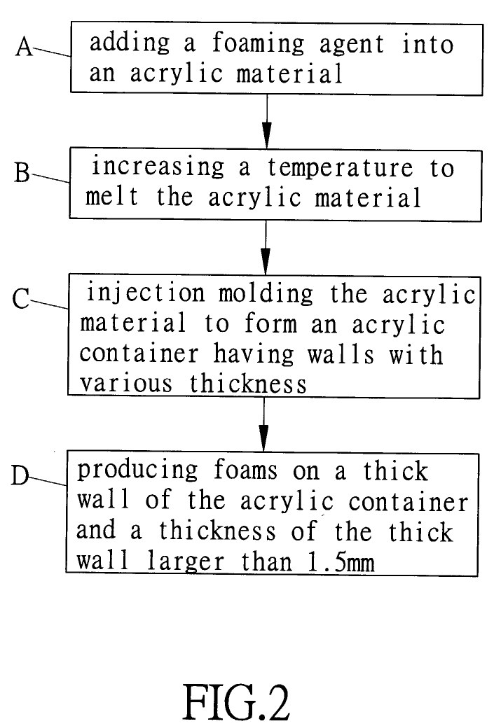

Referring to FIG. 2, a method of preparing a partially foamed acrylic container comprises steps of:

step A: adding a foaming agent into an acrylic material;

step B: increasing a temperature to melt the acrylic material;

step C: injection molding the acrylic material to form an acrylic container having walls with various thickness;

step D: producing foams on a thick wall of the acrylic container, and a thickness of the thick wall larger than 1.5 mm.

When the acrylic material is solidified in a mold, the foams will exist in the thick wall which has a thickness larger than 1.5 mm.

The partially foamed acrylic container is transparent.

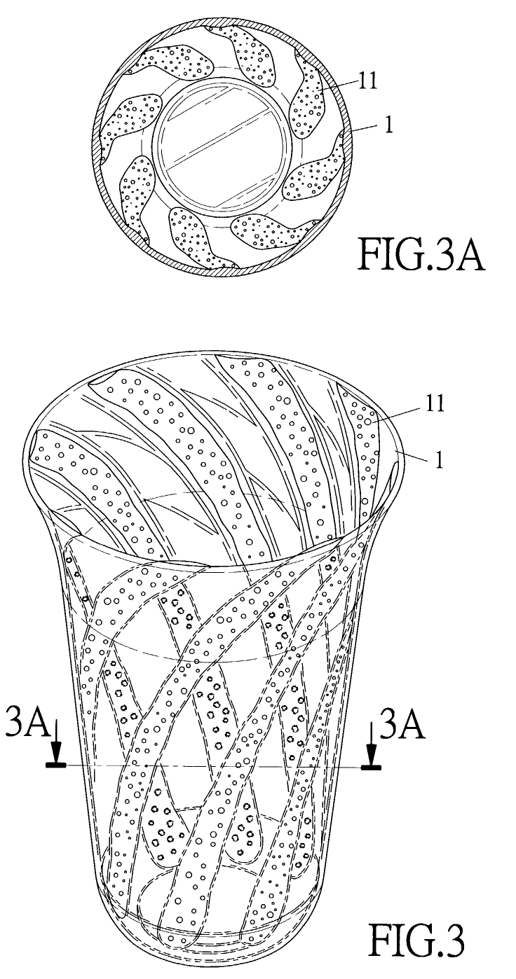

Referring to FIGS. 3 and 3A, a first partially foamed acrylic container 1 has a plurality of inner protruded bars 11.

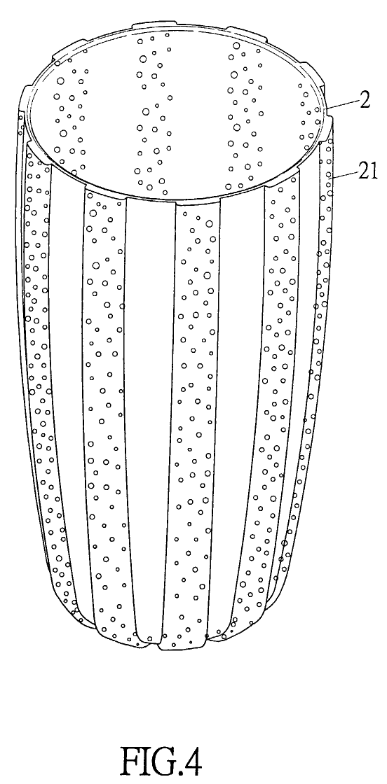

Referring to FIG. 4, a second partially foamed acrylic container 2 has a plurality of outer protruded bars 21.

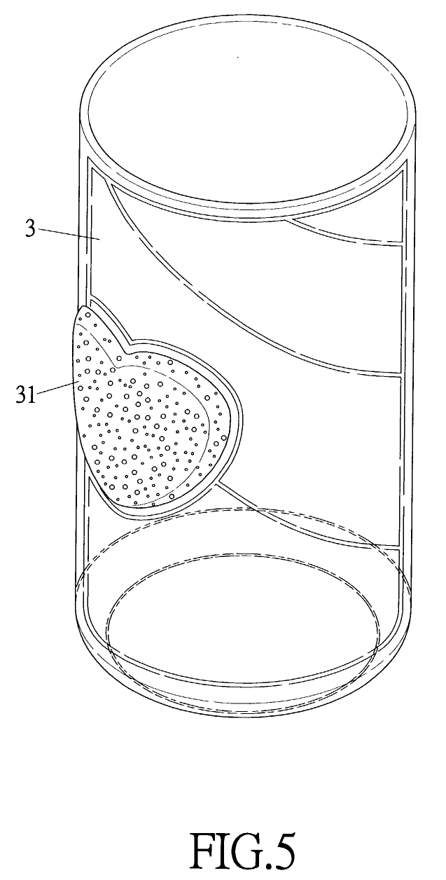

Referring to FIG. 5, a second partially foamed acrylic container 3 has a heart-shaped outer protrusion 31.

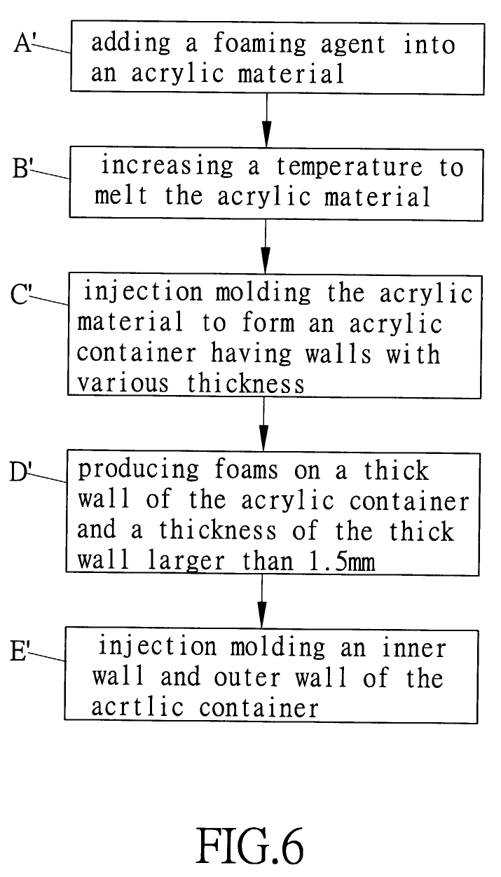

Referring to FIG. 6, another method of preparing a partially foamed acrylic container comprises steps of:

step A′: adding a foaming agent into an acrylic material;

step B′: increasing a temperature to melt the acrylic material;

step C′: injection molding the acrylic material to form an acrylic container having walls with various thickness;

step D′: producing foams on a thick wall of the acrylic container, and a thickness of the thick wall larger than 1.5 mm;

step E′: injection molding an inner wall and an outer wall of the acrylic container.

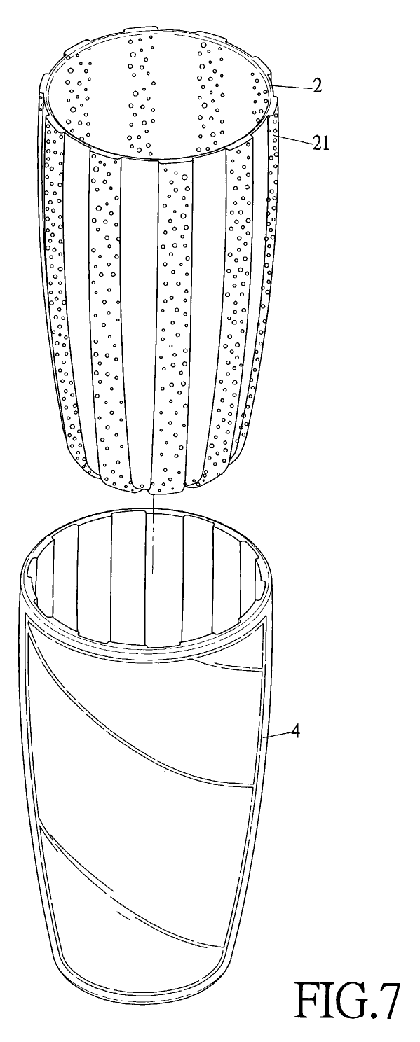

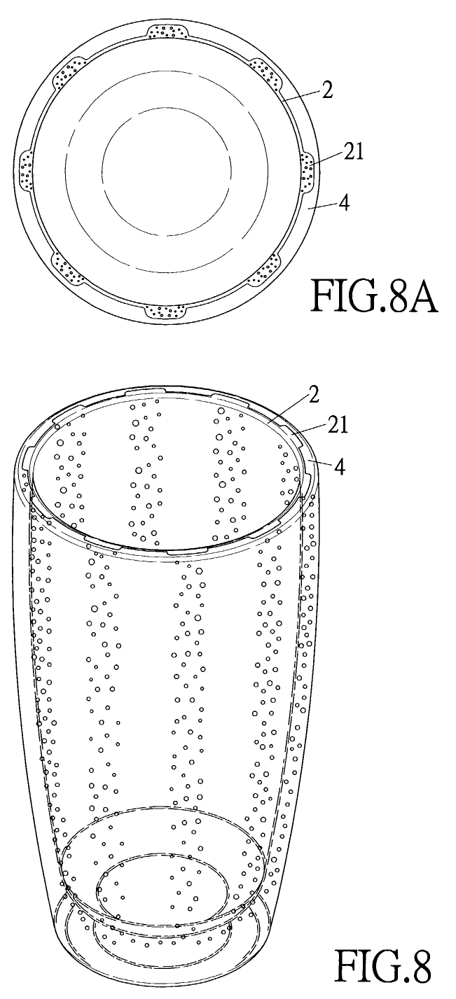

Referring to FIGS. 7, 8 and 8A, an outer casing 4 receives the second partially foamed acrylic container 2.

The invention is not limited to the above embodiment but various modification thereof may be made. Further, various changes in form and detail may be made without departing from the scope of the invention.

I claim:

1. A method of preparing a partially foamed acrylic container comprises steps of:
adding a foaming agent into an acrylic material;
increasing a temperature to melt the acrylic material;
injection molding the acrylic material to form an acrylic container having walls with various thickness;
producing foams on a thick wall of the acrylic container, and
a thickness of the thick wall larger than 1.5 mm.

2. The method of preparing a partially foamed acrylic container as claimed in claim 1, wherein an inner wall of the acrylic container is injection molded.

3. The method of preparing a partially foamed acrylic container as claimed in claim 1, wherein an outer wall of the acrylic container is injection molded.
